(19) United States
(12) Patent Application Publication
(10) Pub. No.: US 2006/0167700 A1
(43) Pub. Date: Jul. 27, 2006

(54) Analysis result providing method and analysis result providing system

(76) Inventor: Taio Sugahara, Tokyo (JP)

Correspondence Address: JOHN S. PRATT, ESQ;KILPATRICK STOCKTON, LLP, 1100 PEACHTREE STREET, ATLANTA, GA, 30309, US

(21) Appl. No.: 10/528,261

(22) PCT Filed: Sep. 18, 2003
(86) PCT No.: PCT/JP03/11925

§ 371 Date: Nov. 7, 2005

(30) Foreign Application Priority Data
Sep. 19, 2002 (JP) 2002-273155

(51) Int. Cl. G06Q 99/00

(52) U.S. Cl. 705/1

(57) ABSTRACT

An analysis management server 1 makes a large variety of question contents from a question providing unit 4 available, registers a group of questions for analyzing an audience in correspondence with selection of a client terminal 3, obtains replies to the question contents corresponding to the client terminal 3 in accordance with an access from an audience terminal 2 and finally provides the client terminal 3 with an analysis result for the audience. This analysis result has a content of a combination of audience's replies to different question contents. Consequently, the analysis management server 1 earns a question using fee and an analysis-result inspecting fee, while part of the question using fee is delivered to a question provider.

### TECHNICAL FIELD

This invention relates to an analysis result providing method and system, for analyzing replies to questions for an analysand, audience to be analyzed, when diagnosing fitness between human resources and companies etc. and for providing an evaluation of the audience as the human resources.

### BACKGROUND OF ART

In a human-power evaluation system described in Japanese Patent Application Laid-open No. 2002-32462, it is carried out to present various types of questions, which are based on question matters (basic matters and applied matters) previously stored in a server, to an analysand thereby urging the analysand to make replies to the questions. The system further analyzes the replies from the analysand to smoothen a matching between the analysand and a company.

### DISCLOSURE OF THE INVENTION

In the above-mentioned human-power evaluation system, however, it is not always responsive to company's needs since the system focuses mainly on analysand's convenience. That is, it hasn't been carried out that a company makes a comparative study for various kinds of question contents and further selects optimum question contents from the question contents freely thereby analyzing an analysand in comprehensive combination with analysand's replies to the selected question contents.

Under such a situation, it is an object of the present invention to provide analysis result providing method and system capable of combining various kinds of question contents provided from a plurality of question providers in analyzing human resources or the like.

According to the present invention, there is provided an analysis result providing method for analyzing an audience in an analysis management server connected to an audience terminal, a client terminal and a question providing unit through communication lines and providing an analysis result to a client, comprising: presenting a number of different and available question contents or themes from the question providing unit to the client terminal; recognizing a group of questions that the client selects from the question contents or the themes presented to the client terminal; memorizing the group of questions and the client in correspondence with each other and memorizing one or plural groups of questions by a plurality of clients registered to the themes correspondingly; when an access including information identifying the client is generated from the audience terminal, presenting the group of questions corresponding to the client to the audience terminal thereby urging the audience to make replies to the questions and, on a basis of the replies obtained, presenting the replies to the client terminal in a browseable form where analysis results by different question contents are combined with each other; or when an access is generated from the audience terminal having a theme nominated, presenting a group of questions corresponding to the theme nominated to the audience terminal thereby urging the audience to make replies to the questions; drafting an analysis based on the replies obtained and presenting the analysis result to a plurality of client terminals registered to the theme nominated,

With the provision of the analysis result providing method, it is possible to obtain a profit with presentation of an analysis result based on audience's replies to the client and also possible for a question provider's side to obtain a profit in correspondence with the usage of the question contents.

Further, in the analysis result providing method and the analysis result providing method of the present invention, the server accumulates a program for executing various kinds of processes, while the client's side displays various information corresponding to the server's processing and mounts a program for transmitting the information to the server, thereby executing the above-mentioned processes.

### BRIEF DESCRIPTION OF THE DRAWINGS

FIG. 1 is a block diagram showing the functional constitution of an analysis result providing system on application of the present invention;

FIG. 2 is a view explaining that the analysis result providing system on application of the present invention drafts an analysis result in the form of a deviation chart combining a general common sense with a technological diagnosis;

FIG. 3 is a view explaining that the analysis result providing system on application of the present invention drafts an analysis result in the form of a deviation chart in case of analyzing audiences A to S while spreading a range to calculate a deviation value up to top performers of industry segments except the audiences A to S;

FIG. 4 is a view explaining the drafting of an analysis result in the form of a category chart where a general common sense and a technology diagnosis are divided into a plurality of categories;

FIG. 5 is a flow chart showing the processing order of an analysis in accordance with the analysis result providing system on application of the present invention;

FIG. 6 is a diagram explaining the kinds of question contents registered in a database storing part;

FIG. 7 is a diagram explaining a question content available with respect to each kind of question contents;

FIG. 8 is a diagram explaining that companies registered in a human-power analysis management server are presented to an audience with respect to each theme;

FIG. 9 is a diagram explaining a group of questions registered with respect to each theme;

FIG. 10 is a diagram explaining the rating of human-power resource and its trends with respect to each company;

FIG. 11 is a block diagram showing the functional constitution of another analysis result providing system on application of the present invention; and

FIG. 12 is a flow chart showing the processing order in accordance with the other analysis result providing system on application of the present invention.

### DETAILED DESCRIPTION OF THE PREFERRED EMBODIMENT

Referring to accompanying drawings, embodiments of the present invention will be described below.

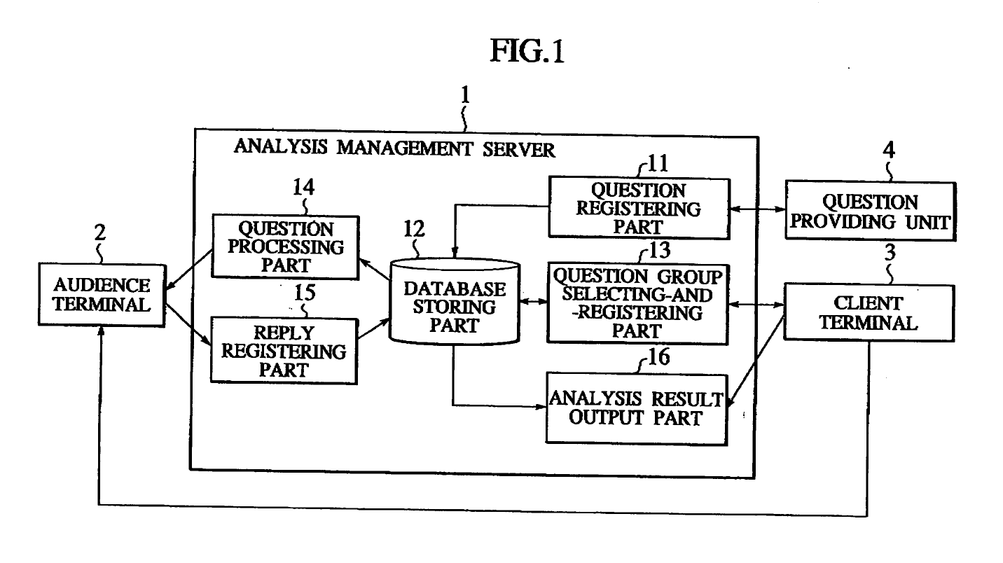

The present invention is applied on an analysis result providing system, for example, that as shown in FIG. 1. In compliance with requests of a registered client, such as company, this analysis result providing system is provided to analyze an audience(s) that the client does require a reply and to provide the client with an analysis result.

In this analysis result providing system, there are carried out to collect large variety of question contents provided by a plurality of question providers (companies, persons), to allow a client to select a question content at a client's desire to use from the question contents when registering the client, to present the so-selected question content variety to an audience when having access to the system and further obtain a reply from the audience, and to present an analysis result to the client. Note, on the clients' side, it is possible to alter the once-selected question content at any time, as occasion demands.

The analysis result providing system like this is used, for example, in case that a client thinks of graduate and intermediate recruitment against job seekers as the audiences, case of evaluating organizations etc. in a company while analyzing abilities etc. of employees and directors, case of diagnosing levels of pupils and teachers and so on.

As a terminal that an audience does use, to say nothing of a personal computer possessed by an audience, a company or a school, there may be a personal computer possessed by a job-intermediation organization administrated by a public institution, a job-intermediation organization in a school or the other reliable civilian agency.

In this way, by analyzing an audience by use of a personal computer possessed by a public institution or a school, it is possible to improve the reliability of analysis results. That is, it is possible to prevent abasement in the authenticity of analysis results, which may come from scapegoat of a fake audience peculiar to so-called “on-line consultation” or dishonesty that a plurality of audiences have a check-up actually while posing as consultation of a single audience.

Consequently, an analysis result providing system mentioned below allows the on-line consultation to be in widespread use and ensures belief on the side of an analysis-result receiver (e.g. client).

Again, according to the analysis result providing system mentioned below, it is possible to save analysis demander's labor to arrange a testing venue and audience's labor to take the trouble of paying a visit to such a testing venue.

Here, it is noted that there can be enumerated a person who wants intermediate recruitment as an audience of the job-intermediation organization administrated by a public institution and a new graduate who wants recruitment as an audience of the job-intermediation organization in a school. In such a case, even if the job-intermediation organization administrated by the public institution and the job-intermediation organization in the school have already possessed question contents provided from a question offer's side, an analysis management server 1 mentioned below is available.

[Structure of Analysis Result Providing System]

In this analysis result providing system, an audience terminal 2, a client terminal 3 and a question providing unit 4 are connected to an analysis management server 1 through communication lines. Note, although FIG. 1 illustrates the audience terminal 2, the client terminal 3 and the question providing unit 4 in one piece each, we describe the structure on the assumption that the audience terminals 2, the client terminals 3 and the question providing units 4 in plural number each are connected to the analysis management server 1 actually.

The audience terminal 2, which is composed of e.g. a personal computer, generates various kinds of information in compliance with audience's operations and further transmits the information to the analysis management server 1. This audience terminal 2 has a function of operational input to be operated by an audience, for example, keyboard and mouse, a display function to present question contents etc. to the audience, a calculating function to perform various calculations in compliance with operated contents, a memory function to store various kinds of information and a transmitter-receiver function to transmit and receive the information to and from the analysis management server 1 through the communication line.

The client terminal 3 composed of e.g. a personal computer is operated by a person in a human resources department belonging to a client for the analysis management server 1. This client terminal 3 has a function of operational input to be operated by the person in charge of human resources, for example, keyboard and mouse, a display function to present various contents to the person in charge of human resources, a calculating function to perform various calculations in compliance with operated contents, a transmitter-receiver function to transmit and receive the information to and from the analysis management server 1 through the communication line and a reference function to submit the analysis result of the analysis management server 1 for an client's inspection,

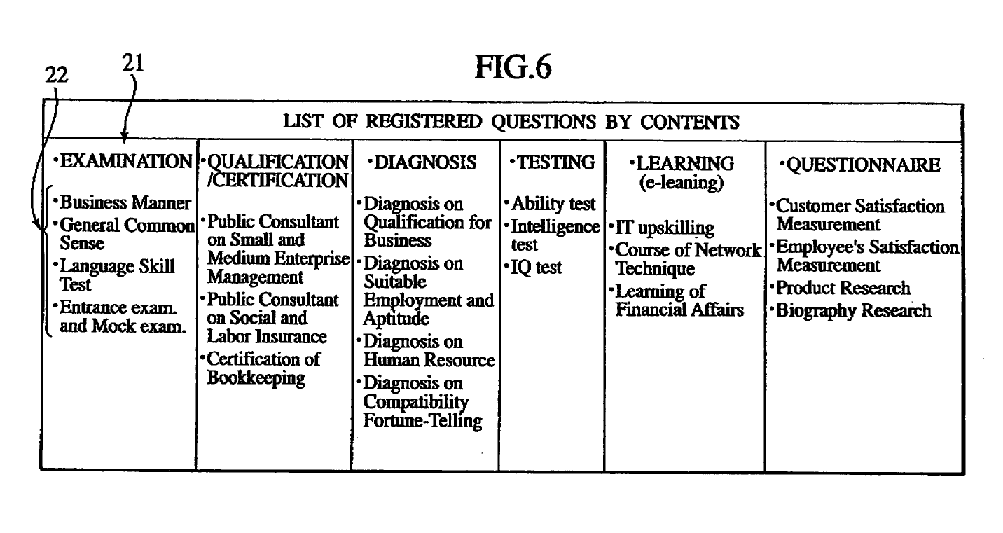

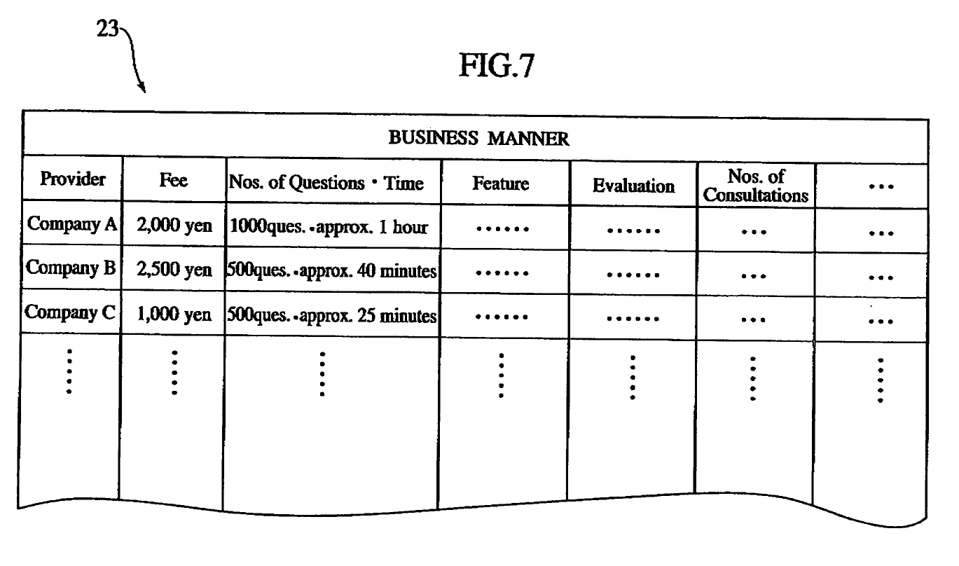

The question providing units 4 are operated by various question providers possessing large variety of question contents 21 (see FIG. 6): examination contents e.g. language skill test, entrance/mock examinations; diagnosis contents e.g. diagnosis on suitable employment and aptitude; qualification contents e.g. public consultant on small and medium enterprise management; certification contents e.g. ability test, brainpower test; learning Contents e.g. so-called “e-leaning” utilizing telecommunications technology; question contents e.g. question about customer satisfaction measurement, question about employee's satisfaction measurement, biographical question (information about personal history, such as academic record and employment record) and so on. These question contents 21 are classified to sub-contents 22 more in detail (In case of the examination contents, for example, the sub-contents may be business manner, general common sense, language skill test, entrance/mock examinations, etc.) Each of the sub-contents 22 is further formed by a provider-by-provider question information 23 (provider, fee, number of questions, time required, features, etc.) (see FIG. 7).

Accordingly, the question contents retained in the respective question providing units 4 have a variety of forms with respect to data format, display format, platform, such as OS (operating system), etc.

This question providing units 4 transmits the question contents to the analysis management server 1 for the purpose of getting the using fee of questions from a manager for managing the analysis management server 1. In this way, large variety of question contents from a plurality of question providing units 4 are available in the analysis management server 1 and it makes payments to the question providing units 4 corresponding to the availment of the question contents,

Regarding the establishment of availability in the analysis management server 1, it means to accumulate the question contents retained in the question providing units 4, URLs allowing the audience terminal 2 to access the question providing units 4 and so on.

A client selects a question content necessary to analyze an audience. Upon gain of a response information from the audience terminal 2 by use of the so-selected question content, the client terminal 3 pays a question using fee due to the usage of the question content and an analysis-result inspecting fee due to the acquirement of the analysis result to the analysis management server 1, Then, the analysis management server 1 or the manager pays part of the question using fee brought from the client terminal 3 to the question providing units 4.

The analysis management server 1 performs the functions shown in FIG. 1 since the server 1 delivers information among various kinds of programs. Note that, FIG. 1 shows the functions that could be accomplished by the following events of: storing various programs in a hard disc or the like previously; reading out the various programs into RAM (Random Access Memory) when activated; and executing the programs by means of a CPU (Central processing Unit) or a communications interface circuit.

[Detailed Structure of Analysis Management Server 1]

This analysis management server 1 includes a question registering part 11 that receives and registers the question contents from the question providing units 4. In registering the question contents in a database storing part 12, this question registering part 11 operates to allow information for identifying the question providers, information showing respective question using fees and the question contents to correspond to each other.

A question group selecting-and-registering part 13 presents a list of question contents to the client terminal 3 whenever it requires inspecting the question contents available as a result of registration in the database storing part 12. Then, the question group selecting-and-registering part 13 presents respective names of the question contents, sub-contents belonging to these question contents, question information by individual providers belonging to these sub-contents, evaluations and features of the question contents (the question information by individual providers), the number of questions and time required and using fees of questions, in association with each other.

Alternatively, registering unit prices for discounting the question using fee in case of using plural and different question contents at a time, package prices for discounting a question using fee per usage corresponding to the number of audiences using the same question content, respective evaluations of the question contents, frequency of usage, etc. in the database storing part 12, they may be presented to the client.

Again, registering a fee structure for discounting an analysis-result inspecting fee in the database storing part 12 on condition of presenting the identical analysis (including both of an analysis result on use of a single question content and another analysis result on use of plural question contents), the fee structure may be presented as occasion demands. Additionally, it is allowed to set an information disclosing fee dependently on the content of an analysis result, such as ranking. Then, for instance, the information disclosing fee may be established high for top ranks of audiences. Moreover, the information disclosing fee may be changed in accordance with the disclosing order of audiences and alternatively, the information disclosing fee may be established in a so-called “auction” manner.

Further, it is allowed to present information allowing a client to designate that audiences on use of the question content can be selected by the client in stages, corresponding to the analysis result. Concretely, for instance, it may be established that when analyzing a plurality of audiences, the client can designate to analyze thousand audiences by a question content A first, top three hundreds audiences of the thousand audiences by a question content B secondly and top hundred audiences of the three hundreds audiences by a question content C furthermore. In this way, without forcing thousand audiences to be asked all of the question contents A, B, and C, it is possible to allow the client to select the question using fee on the client's side in stages.

Alternatively, when there is an analysis result for a plurality of audiences, it is allowed to present information capable of selecting an audience that a question content will be presented corresponding to the analysis result and also capable of presenting a different question content to the selected audience. Consequently, on condition of making the client refer to the analysis result, it is possible to obtain an audience's reply on the presentation of the different question content corresponding to the analysis result of the selected audience. Again, in case of a single audience, it is also allowed to present a capability of altering a next-presented question content corresponding to the analysis result of a certain question content.

Further, when there exists an analysis result for a plurality of audiences, it may be carried out to present a capability of designating to select the analysis result of the audiences and successively disclose it in stages to the client. For example, in an analysis with respect to each theme, it may be established that when thousand audiences are asked the question contents A, B and C, the client can designate to disclose the analysis result of the question content A for thousand audiences, the analysis result of the question content B for only top three hundreds audiences of the thousand audiences, and the analysis result of the question content C for only top one hundred audiences of the three hundreds audiences. Consequently, it is possible for the client to save an information disclosing fee. In comparison with the case of selecting the replying audiences in stages, additionally, by allowing thousand audiences to asked three question contents respectively, it is possible for the client to inspect the analysis result of the audience promptly. In case of disclosing the analysis result in the above way, if there exists an audience that has not transmitted the replies to all of the question contents A, B and C yet, it is carried out to urge all audiences or the audience for disclosure to reply to the question content(s).

On detection of the client terminal 3 selecting the question contents in response to the presentation of the list of question contents, the question group selecting-and-registering part 13 registers a group of questions composed of plural question contents in the database storing part 12. Then, the question group selecting-and-registering part 13 makes the information identifying the client terminals 3 correspond to the group of questions selected at the client terminals 3.

In such a condition, there are constructed a “question” database having the question contents corresponding to the question providers and a “client” database having the question contents correspond to the client terminals 3, in the database storing part 12.

In order to allow the audience to be asked a question on receipt of the access of the audience terminal 2, the client terminal 3 transmits the analysis information including URL (Uniform Resource Locator) for inspecting the contents of questions, password and ID to access the analysis management server 1, a company's ID for identifying the client, etc. to the audience terminal 2.

Receiving the analysis information, the audience terminal 2 accesses the analysis management server 1 on use of the analysis information and further transmits the response information to the questions to the analysis management server 1. While, the analysis management server 1 presents the contents of questions to the audience terminal 2 through a question processing part 14 and receives the response information to the questions at a reply registering part 15. At the reply registering part 15, it is carried out to register respective questions included in the question contents and the response information in the database storing part 12, correspondingly one by one.

When the information about all replies to the questions required by the client terminal 3 is accumulated in the database storing part 12, an analysis-result output part 16 performs a data processing for presenting an analysis result to the client terminal 3 on the basis of the response information and presents the analysis result at request of the client terminal 3.

At this time, the analysis-result output part 16 performs a data processing to process the analysis result to a variety of forms, for example, matrix, graph, chart, ranking form, etc. In this data processing, there are carried out a calculation of a deviation value with an audience's raw score (point) based on the replies of the respective question contents and respective points of the other audiences, another calculation of a deviation value with an audience's point in diagnosis with a plurality of different question contents in combination and points of the other audiences, and so on. Additionally, this data processing allows the client to perform a conditional inspection using the analysis result, a composite analysis, etc. It is allowed to perform this data processing either in the analysis management server 1 or in the client terminal 3 independently. Alternatively, it may be performed by both of the analysis management server 1 and the client terminal 3.

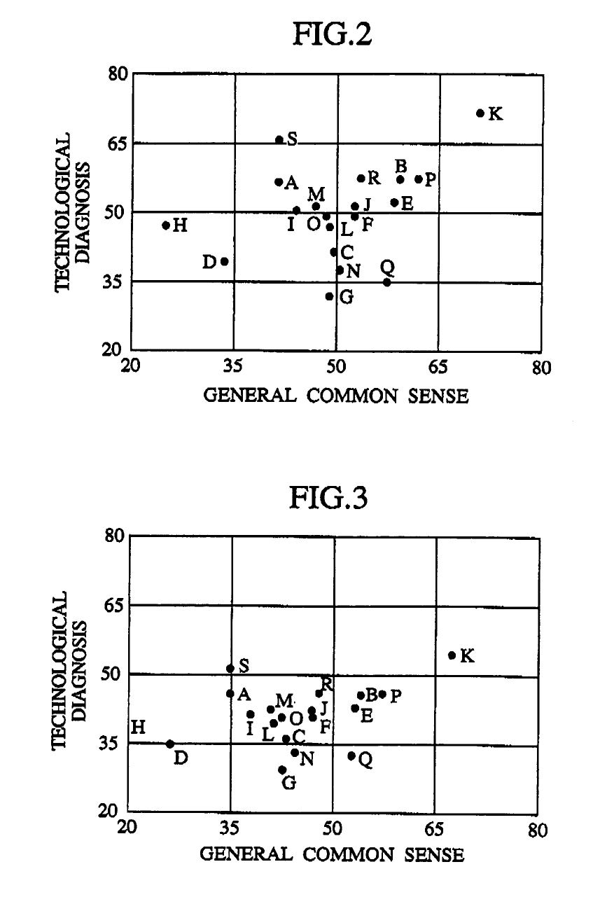

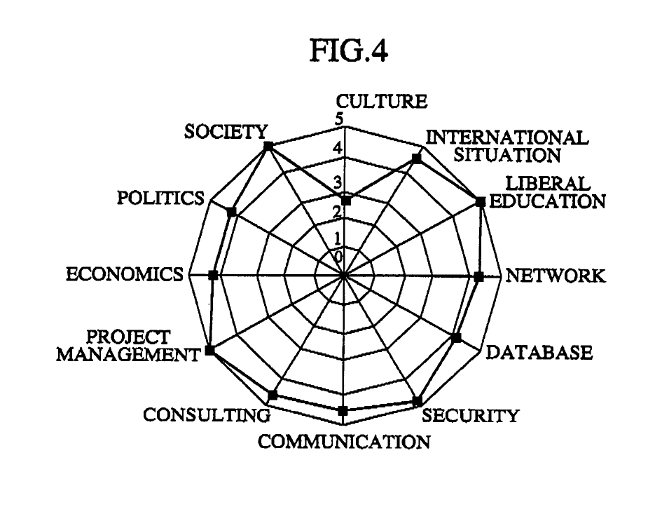

Concretely, for instance, when obtaining replies of audiences A to Z in the presentation of two kinds of question contents in terms of the general common sense of a company ZZ and the technological diagnosis of a JJ company in analyzing human resources in the IT market, there is drafted an analysis result where the individual audiences A to S are plotted in a diagram having deviation values in a horizontal axis of the general common sense and deviation values in a vertical axis of the technological diagnosis, as shown a deviation chart of FIG. 2. By FIG. 2, it is possible to present a combined distribution of respective deviation values of the audiences A to S in terms of the general common sense and the technological diagnosis to the client.

Additionally, when comparing the analysis result of the deviation chart of FIG. 2 as a result of calculating the deviation values in the so-limited audiences A to S with an analysis result obtained as a result of calculating deviation values of top performers in a wider range except the audience A to S in the IT market, it is found that the deviation values in the general common sense and the deviation values in the technological diagnosis drop in spite of the identical audiences A to S, as shown in FIG. 3. That is, the analysis management server 1 can draft a comparative analysis result by accumulating not only the analysis result of the audiences A to S but the other analysis result of top performers etc. in the database storing part 12.

Alternatively, on condition of classifying the general common sense and the technological diagnosis into a plurality of categories, the analysis management server 1 may draft a category chart of Fig, 4 as the analysis result. In this case, the general common sense is divided to categories, for example, economics, politics, society, culture, international situation and liberal education, while the technological diagnosis is divided to categories, for example, network, database, security, communication, consulting and project management. This category chart is expressed, as deviation values by categories, in five stages with respect to each element forming the general common sense and the technological diagnosis.

In this way, the analysis results by different question contents are combined to a browseable form in the analysis-result output part 16. Further, as another process for providing a browseable form from the combined analysis results by different question contents into, it is also included to separately process e.g, the ranking about row scores/deviation values of the general common sense for the audiences A to S, the ranking about row scores/deviation values of the technological diagnosis for the audiences A to S, the ranking about the total of general common sense and technological diagnosis for the audiences A to S and so on, thereby providing a browseable form on an identical platform.

[Analysis of Analysis Result Providing System]

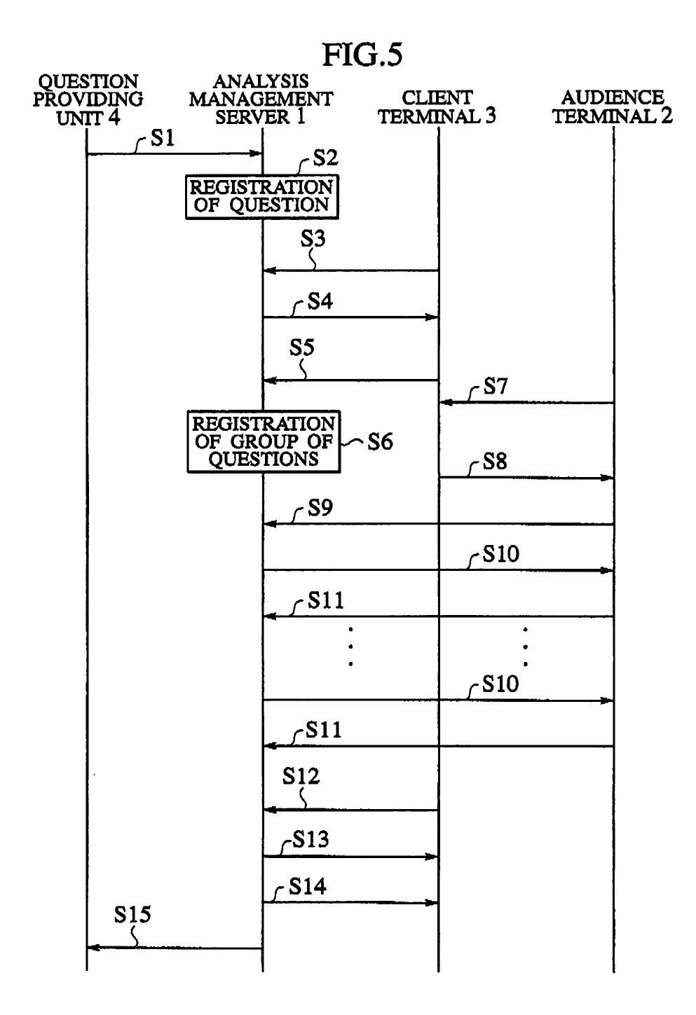

Next, one example of analysis by the above-constructed analysis result providing system will be described with reference to FIG. 5.

In performing an analysis, the question providing unit 4 first transmits a question content to the analysis result management server 1 (S1). Then, in the analysis result management server 1, the question registering part 11 registers the question content in the database storing part 12 (S2). This operation is executed with respect to each demand of the question providing unit 4 to register a question content, Consequently, the database storing part 12 has large variety of question contents accumulated and provided from different question providers. Here, the database storing part 12 may accumulate not only the question contents but URLs making the question contents of the question providing unit 4 available or the like.

The, when an inquiry to use a question content is transmitted from the client terminal 3 to the analysis result management server 1 (S3), the question group selecting-and-registering part 13 reads information about the content-by-content question list for informing the kinds of registered question contents as shown in FIG. 6, out of the database storing part 12 and transmits the information to the client terminal 3 (S4). Here, the question group selecting-and-registering part 13 drafts the information about the content-by-content question list while classifying questions to various kinds of contents, for example, examination, qualification/certification, diagnosis, testing, learning, question, etc. If the side of the client terminal 3 selects, for example, the item of business-manner of FIG. 6, then the list of question contents about business manner available in the database storing part 12 is transmitted as the information about question list (information about questions by providers), as shown in FIG. 7.

Next, when it is detected that the client terminal 3 selects a plurality of question contents with reference to the information about question list, the question group selecting-and-registering part 13 receives a question-group selecting information on selection (S5). On the basis of the selection-group selecting information, the question group selecting-and-registering part 13 registers an information for identifying the client and a group of questions in correspondence with each other, in the database storing part 12 (S6).

Next, when the audience terminal 2 under a request of the client accesses the client terminal 3 and sends a request of analysis to it (S7), the client terminal 3 transmits an analysis information allowing an analysis with a group of questions on previous selection to the audience terminal 2 (S8). Note, without being limited to a case that an audience accesses the client terminal 3 to obtain the analysis information and successively accesses the analysis management server I only, the audience may access the analysis management server 1 by means of password, ID, etc. issued on the side of the client terminal 3 and subsequently served to the audience through homepages, mails or the like.

Next, the audience terminal 2 accesses the analysis management server 1 by use of the analysis information, Then, the question processing part 14 in the analysis management server 1 identifies the client by the analysis information (S9), reads a group of questions corresponding to the client out of the database storing part 12 and sends information of a question to the audience terminal 2 (S10). Correspondingly, with input of a reply in compliance with an audience's manipulation, the audience terminal 2 drafts information of the reply and sends it to the analysis management server 1 (S11). On receipt of the information of reply, the analysis management server 1 makes the reply correspond to the question in the reply registering part 15 and further accumulates the reply in the database storing part 12.

Then, by repeating the notice of question and the transmission of reply (S10) and the registration of reply (S11) at the question processing part 14, the audience terminal 2 and the reply registering part 15, the analysis management server 1 obtains the information of replies to all questions included in the group of questions selected by the client terminal 3.

After the reply registering part 15 judges that the information of replies to all questions included in the group of questions is registered in the database storing part 12, the information of replies is analyzed, so that the analysis-result output part 16 drafts an analysis result.

Then, when an inquiry about an analysis result is transferred from the client terminal 3 to the analysis-result output part 16 (S12), it send the analysis result to the client terminal 3 (S13) and subsequently, the analysis management server 1 requests payments of the content using fee and the analysis-result inspecting fee (S14). In this request for payment, there are included a process to perform a data-processing so as to computerize a content using fee and an analysis-result inspecting fee earned thereby presenting them automatically and another process to inform an manager of the analysis management server 1 of an client whom both of the content using fee and the analysis-result inspecting fee are generate to.

On completion of payments of the content using fee and the analysis-result inspecting fee by the client, part of the content using fee is paid to the question provider's side (S15). In this payment process, there are included a process to perform a data-processing so as to computerize to make a payment to the question provider's side at the point of completing a payment of the client terminal 3 thereby presenting the information automatically and another process to inform the manager of the analysis management server 1 of a question provider whom a payment to the question provider's side is generate to.

Then, on condition of counting the number of times of using the respective question contents, the analysis management server 1 is allowed to make a payment while presenting both of available question contents and the number of times of using these question contents in correspondence with each other, to the question provider's side. Consequently, it is possible to recognize the question contents used on the question provider's side and also possible to confirm such paid-up fees etc.

Without being limited to only the case that a payment is required whenever the analysis result is obtained and a payment to the question provider's side is made after confirmation of the former payment, the analysis management server 1 is allowed to request a fixed amount, which corresponds to the number of times of using the question contents at the point of selecting the question content, to the side of the client terminal 3 and also allowed to pay part of the fixed amount to the question provider's side.

Again, in a system such that the audience terminal 3 pays a question using fee and an analysis result inspecting fee between the client and the analysis management server 1, a payment is requested at the point of obtaining a reply to the question content, while an analysis result is provided to the client terminal 3 at the point of receiving the payment.

In the above-mentioned analysis result providing system, when presenting a plurality of question contents successively, the analysis management server 1 is allowed to obtain successive replies and further draft an analysis result. In a further case of presenting a plurality of question contents included in the registered groups of questions to the audience terminal 2 at different times on different days, the analysis management server 1 is allowed to obtain replies each having different dates and hours and draft an analysis result by combining the replies with the other replies in the temporal vicinity of the former replies.

Although the above-mentioned analysis result providing system is described by an example of analyzing a combination of replies to a group of questions of a plurality of question contents, it is a matter of course that the same system can obtain an analysis result on the presentation of a single question content to the audience terminal 2.

Further, although the above-mentioned analysis result providing system is formed by a plurality of audiences, a single analysis management server 1, a plurality of question providers and a plurality of clients, of course, the invention is applicable to a system using large variety of contents in set to a single audience, a system for analyzing a number of audiences by a single question provider in a package and a system for analyzing a single audience with one or more question contents for a number of clients.

Still further, although the above-mentioned analysis result providing system is described by an example of analyzing replies of the audience terminals 2 by the analysis management server 1, the invention is not limited to this example. As for the other method for transmitting replies of the question contents to the analysis management server 1, it is possible to bring out the similar effects to the above-mentioned system even if replies described on papers, such as computer-scored answer sheets, are transmitted to the analysis management server 1 by means of a scanner or even if a scoring result that a third party, such as question provider, has made on the basis of replies is transmitted, in the form of data, to the analysis management server 1.

### Effects of Embodiments

According to the analysis result providing system performing the above processes, it is possible to make various kinds of question contents from the contents providing unit 4 available in the analysis management server 1 and possible to register a group of questions for analyzing an audience corresponding to selecting of the client terminal 3.

Thus, according to the analysis result providing system, it is possible to use large variety of question contents from the question providing unit 4 in combination and also possible to provide the client with replies to large variety of questions in a single platform, allowing human analysis on the side of the client terminal 3 with ease. That is, when intending to obtain an analysis result on the side of the client terminal 3 by use of contents on the question provider's side, it is often the case of impossibility of performing an analysis having a combination of respective analysis results by a plurality of question providers in spite of the possibility of obtaining analysis results with respect to each of the question providers. This is because the respective question providers adopt different data formats and different platforms from each other. While, according to this analysis result management system, it is possible to apply a batch processing on respective replies to different question contents provided by the respective question providers and also possible for the analysis management server 1 to draft an analysis result in an identical data format and an identical platform. Additionally, it is possible to obtain a composite analysis result where respective analysis results about different questions are combined. Consequently, it is possible to accomplish an analysis to compare an audience relying to the questions with the other group of audiences (by age, by business world, etc.), an analysis drafting a graph combining large variety of question contents and so on.

Accordingly, according to this analysis result providing system, it is possible to allow a client to select appropriate question contents, realizing a multidisciplinary and compositive analysis by use of large variety of question contents.

Alternatively, when the analysis management server 1 does not accumulate the question contents on the question provider's side but manages only URLs, this analysis result providing system accumulates the replies from the audience terminal 2 analytically and drafts an analysis result of the replies in combination with the other question contents. Again, in the analysis result providing system, when the question provider drafts an analysis result based on the replies under condition of managing URLs only, the analysis management server 1 receives the analysis result from the question provider and drafts an analysis result in combination with the other analysis results. Furthermore, if using a single question content to present an analysis result employing the above question content, it is allowed to present a server accumulating the analysis results by means of its URL or the like. Alternatively, the analysis result may be delivered in the form of a mail.

Again, according to this analysis result providing system, the analysis management server 1 can earn a question using fee and an analysis-result inspecting fee, while the question provider can earn part of the question using fee.

Additionally, corresponding to acquirement of the replies from the audience terminals 2, the analysis management server 1 can present a value change of human resources manipulating the audience terminals 2.

Further, if this analysis result providing system analyzes audiences forming an organization etc., then it is possible to allow organization structures in companies, human arrangement/posting, class composition in schools or the like to be more effective and optimum.

Still further, according to this analysis result providing system, it is possible to develop a new business where the analysis management server I becomes either a certification organization or a specify feature against job-intermediation organizations administrated by public institutions or job-intermediation organizations in schools and further issues respective certificates corresponding to the analysis results of the audience terminals 2. In detail, in this analysis result providing system, the audience terminals 2 are arranged in companies etc. certified by the job-intermediation organizations administrated by public institutions or the job-intermediation organizations in schools, while the database storing part 12 registers replies and analysis results in the forms corresponding to IDs or passwords issued in obtaining the replies. Here, it is noted that the analysis management server 1 is provided with a gateway etc. allowing the replies and the analysis result to be accumulated while excluding interpolation by the outsiders and leakage to the outside.

Consequently, for example, when the requirements for audiences are presented from a company etc. to a job-intermediation organization administrated by a public institution or a job-intermediation organization in a school, the analysis management server 1 can present the analysis results in the form of certificates describing the analysis results of the audiences.

Note, in the above-mentioned example, the client terminal 3 only is provided with the analysis result. In the modification, the analysis result may be provided to the audiences, too. Then, it is allowed to provide the client and the audiences with the analysis results of the same contents or different contents. For instance, it may be supposed that the client terminal 3 is provided with an analysis result about relative evaluation of an audience to the other audiences, while the audience is provided with an analysis result excluding the above analysis result about relative evaluation.

Additionally, with a contract between a client and the analysis management server 1, the analysis result providing system is allowed to make a question content on selection of the client available to an audience for the aim of self-development of the audience, ability-confirmation, etc. In this case, the analysis result may be presented to the audience only.

[Other Analysis by Analysis Result Providing System]

Next, other techniques of the above-mentioned analysis will be described.

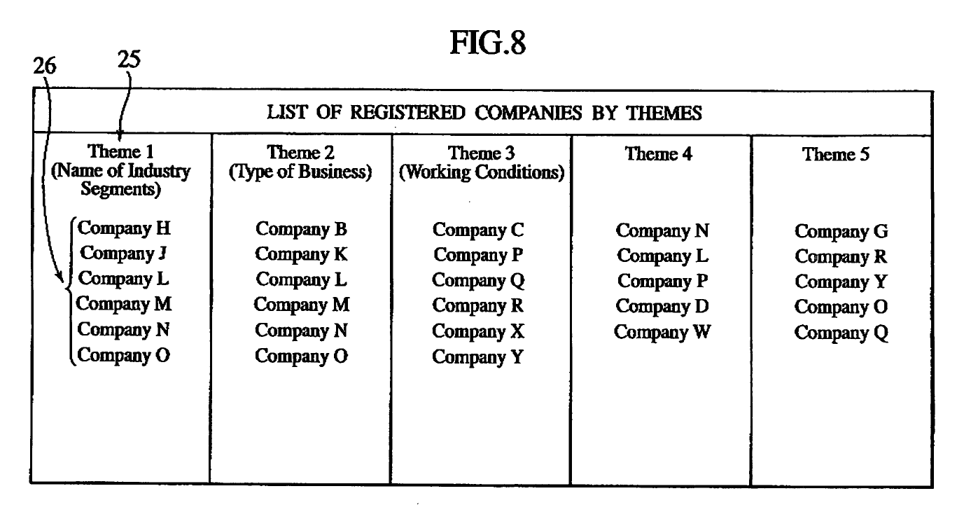

In this analysis, when the audience terminal 2 accesses a portal site making use of the analysis management server 1, as shown in FIG. 8 (list of registered companies by themes), the server 1 presents clients' names 26 registered in the database storing part 12 and also themes 25 as being one example of references registered by these clients and further allows the audience terminal 2 to select either the clients' name 26 or the theme 25. As for the themes 25, there are listed recruiting themes, industry segments, type of business, working conditions, etc. Alternatively, the theme 25 on presentation may be drafted by the side of the analysis management server 1 or it is allowed to use a theme required by the client. In case of establishing themes on the side of the analysis management server 1, the standard of recruitment (i.e. established themes) is presented to the client terminals 3 to collect clients' registrations and successively, the registered clients are memorized in combination with the themes on presentation. Note that, FIG. 8 shows a situation to present the clients registered for the standard of recruitment to the audience terminal 2. In the modification, it is allowed to present the standard of recruitment (i.e. established themes) only.

When the audience terminal 2 selects the client's name 26, the question processing part 14 in the analysis management server 1 reads a group of questions selected by the client out of the database storing part 12 and the reply registering part 15 obtains the response information upon a notification of questions.

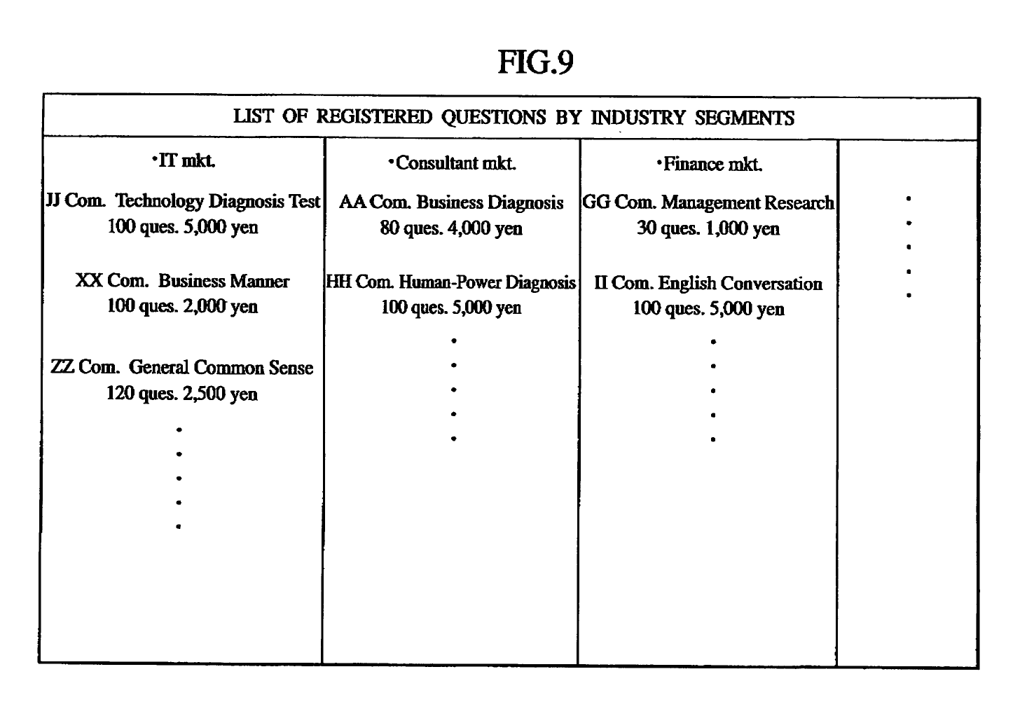

On the other hand, when the audience terminal 2 selects Theme 1 (industry segment), the question processing part 14 reads a group of questions as shown in FIG. 9 (list of registered questions by industry segments), for example, technology diagnosis test corresponding to the IT market, XX's business manner, ZZ's general common sense, etc. out of the database storing part 12 and the response registering part 15 obtains the response information upon a notification of questions.

Additionally, it is allowed to present the group of questions of FIG. 9 to the client terminal 3. Then, even if the audience terminal 2 doesn't have direct access to respective clients, it is possible to register the questions in the client terminal 3 in acquiring an audience desiring a specified theme. In such a case, providing that the database storing part 12 registers the clients corresponding to the names of themes and the groups of questions, when obtaining an analysis result for a designated theme, the system allows the registered client to inspect the analysis result.

In this regard, the groups of questions corresponding to respective themes are registered in the database storing part 12 under condition that e.g. a manager in charge of analysis of human resources selects a question content in advance. On such a presupposition, it becomes possible to provide an analysis result at a request of the client terminal 3.

According to the above-constructed analysis result providing system, the groups of questions are established by the client terminals 3 and also the themes. Therefore, when the audience terminal 2 is required to make a reply from plural clients registered to an identical theme, it is possible to prevent the reliability of analysis result from being reduced due to uncertainty that an audience is frequently subjected to be asked similar questions by the clients. That is, it is possible to exclude wontedness of an audience to the questions, which is caused by the same audience being asked the same question several times and also possible to prevent an audience's impossibility of obtaining an appropriate analysis result corresponding to an actual ability of the audience. Further, there is no need for an audience to be asked similar questions several times, thereby lightening an audience's burden.

According to the analysis result providing system, even if a client selects question contents provided from different question providers, it is possible to provide the client with a single analysis result having combined replies to the different question contents.

According to the analysis result providing system, also in case of going about getting a job by themes on the side of the audience terminal 2, if only analyzing an examination etc. with respect to each theme once for all, then it is possible to present the analysis result to a plurality of clients.

Still further, according to the analysis result providing system, it is possible to save labor to select a group of questions by the client terminals 3, providing the side of the client terminals 3 with higher service.

According to the analysis result providing system, in case of providing a plurality of clients with an analysis result about one audience, if there is an overlap in a plurality of question contents selected by the respective clients, it is also possible to obtain the audience's reply by once presenting the overlapped contents to the audience. Then, the analysis management server 1 recognizes the question contents that an audience was asked in the past. Consequently, even when a plurality of clients require an analysis result about an audience, it is possible to save labor to allow the audience to be asked the same question.

[Rating of Clients by Analysis Result Providing System]

In the above-mentioned example, there is described a method of presenting a group of questions to the audience terminal 2 for the response information when an audience wants to get employed by a client. While, if audiences to be analyzed are identical to company servants or executive officers included in a client, the analysis management server 1 can carry out a rating of the client.

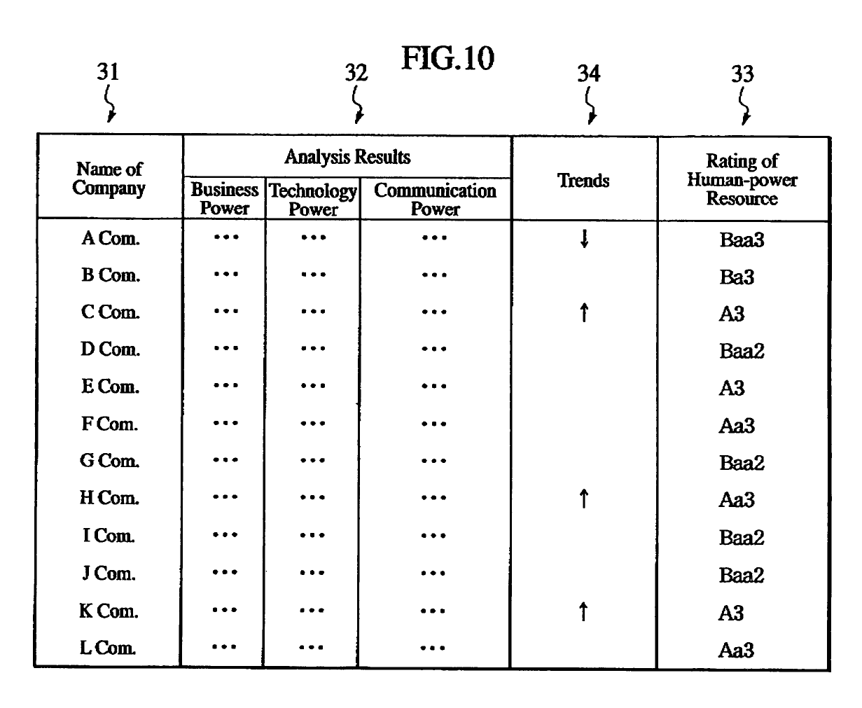

That is, in the analysis management server 1, it is carried out to allow company servants or executive officers in respective clients to be asked a group of questions selected by the clients or managers in charge of analysis of human resources and subsequently, the human resources in the clients are rated in ranking with the use of analysis results obtained. Then, as shown in e.g. FIG. 10, the analysis-result data is processed so as to draft a rating data where clients' names 31, analysis results 32, human-power resources ratings 33 and trends of rating 34 correspond to each other.

The analysis management server 1 accumulates the above rating data as information for investors, providing a barometer in estimating the clients. With the operation of the analysis management server 1, it is possible to develop a business to generate a data providing fee corresponding to the number of inspected rating data (number of clients) whenever e.g. an investor etc. requires to inspect the rating data of the clients.

The above description is related to the rating of clients brought by analyzing the company servants in the clients. Without being limited to this, it is allowed to analyze pupils in schools, teachers, etc. for the rating of schools or the like, providing a barometer for admission etc. Additionally, this rating operation is also applicable to an analysis of a group different from the client. Moreover, it is also allowed to analyze clients for rating on an outside request.

### Another Embodiment of Analysis Result Providing System

Next, another embodiment on application of the present invention will be described. Note that, although processes and descriptions similar to those of the above-mentioned analysis result providing system are eliminated, it is a matter of course that such operations can be accomplished by respective parts mentioned later.

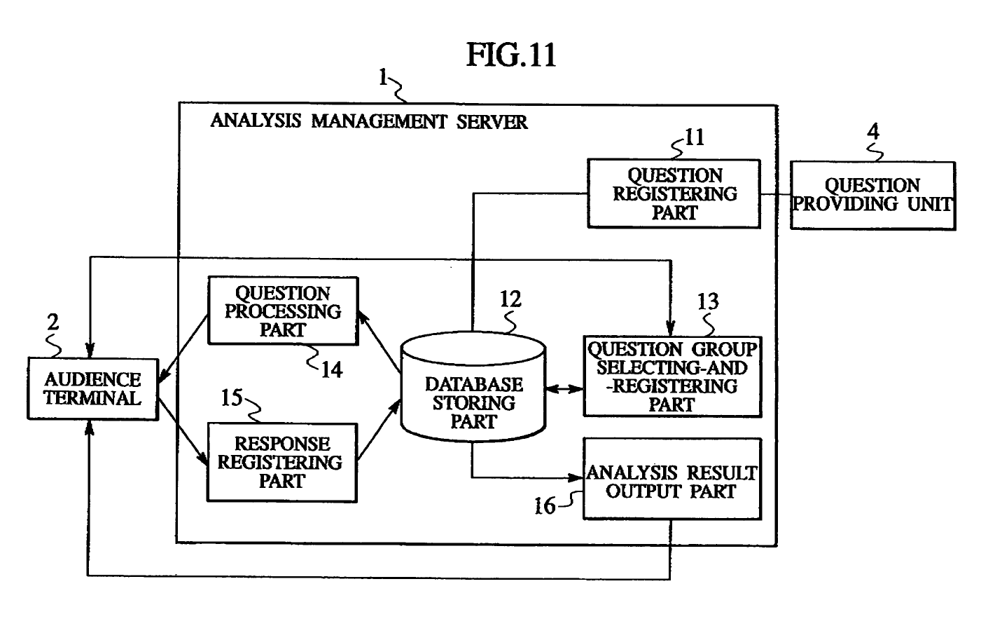

As shown in FIG. 11, this analysis result providing system does not include the client terminal 3 and the audience terminal 2 selects a question content registered as being available in the database storing part 12. Then, the question group selecting-and-registering part 13 presents the information shown in FIGS. 6 and 7, as similar to the above descriptions. While, the analysis management server 1 drafts an analysis result from an audience's replies to the questions and further transmits the result from the analysis-result output part 16 to the audience terminal 2.

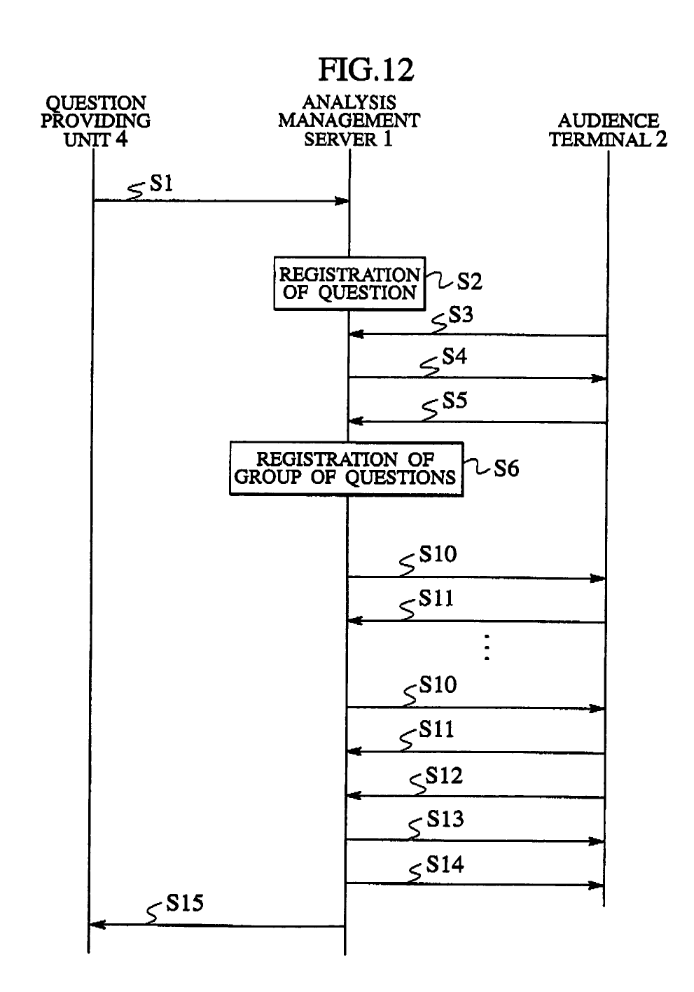

Such an operation of the analysis result providing system is shown in FIG. 12. In this analysis result providing system, when an inquiry as to questions is generated from the audience terminal 2 (S3) on condition of registering the question contents in the database storing part 12 at step S2, the question group selecting-and-registering part 13 transmits the list of questions to the audience terminal 2 (S4). Then, when the audience terminal 2 selects a question-group selecting information S4, the so-selected question content is registered at step S6, thereby giving and taking the notification of the questions and the response information (S10, S11).

Next, when the audience terminal 2 inquires about an analysis result to the analysis management server 1 (S12), the analysis result is transmitted from the analysis management server 1 to the audience terminal 2 (S13) and successively, a request for payment is transferred from the analysis management server 1 to the audience terminal 2 (S14). Consequently, the audience terminal 2 obtains the analysis result as a result of replying to the questions and also recognizes an occurrence of the payment as a result of obtaining the analysis result by use of the question content.

Next, when the audience terminal 2 makes a payment in response to the request for payment and the analysis management server 1 receives the payment, a payment to the question providing unit 4 occurs (515), so that the analysis management server I makes the payment to the question provider side.

In the analysis result providing system like this, when presenting the list of questions to the audience terminal 2, it is possible to carry out mock examinations etc. to industry segments, companies, schools, etc. by demonstrating a question content for self-diagnosing in advance to the entrance for a certain industry segment, company, school, etc. or demonstrating a question contents of high estimation and reputation.

Note, in one example shown in FIG. 12, the request for payment is made after providing the audience with the analysis result and part of the question using fee is paid to the question provider's side after receiving the payment. Alternatively, without being limited to this, it is allowed for the system to request a payment before providing an analysis result or at the point of selecting a group of questions. Hereby, it is possible to prevent an outstanding balance of the audience.

According to the analysis result providing system of the other embodiment, additionally, on condition of accumulating analysis results by audiences together with unchangeable information, such as consultation IDs or passwords issued from the analysis management server 1, it is possible to realize a business where the analysis management server 1 issues a certificate corresponding to the analysis result of an audience at an audience's request.

### INDUSTRIAL APPLICABILITY

According to the present invention, on condition of making large variety of question contents from the question providing unit, it is possible to register a group of questions for analyzing an audience in response to a client's selecting or an audience's selecting and also possible to present an analysis result meeting a client's request or an audience's request. Thus, according to the present invention, it is possible to accomplish business employing large variety of question contents from the question providing unit in combination. That is, according to the present invention, it is possible to earn a question using fee and an analysis-result inspecting fee, while the question providing unit side can obtain part of the question using fee.

What is claimed is:

1. An analysis result providing method for analyzing an audience in an analysis management server connected to an audience terminal, a client terminal and a question providing unit through communication lines and providing an analysis result to a client, comprising:
presenting a number of different and available question contents from the question providing unit to the client terminal;
recognizing a group of questions that the client selects from the question contents presented to the client terminal;
memorizing the group of questions and the client in correspondence with each other;
when an access including information identifying the client is generated from the audience terminal, presenting the group of questions corresponding to the client to the audience terminal thereby urging the audience to make replies to the questions and further obtaining the replies; and
presenting the replies to the client terminal, in a browseable form where analysis results by different question contents are combined with each other, based on the obtained replies.

2. The analysis result providing method of claim 1, wherein
it is carried out to present a question-group using fee in case of obtaining the replies as a result of presenting the question contents to the audience terminal, thereby urging the client terminal to select the question contents.

3. The analysis result providing method of claim 1, wherein
when using a plurality of different question contents, it is carried out to present a discounting of a question-group using fee.

4. The analysis result providing method of claim 1, wherein
when receiving a payment of a question-group using fee in case of obtaining the replies as a result of presenting the question contents to the audience terminal, it is executed to pay part of the question-group using fee to the side of the question providing unit.

5. The analysis result providing method of claim 1, further comprising:
allowing the analysis result of the audience based on accumulated replies to correspond to information identifying the audience and further accumulating the analysis result and the information in an outside-leakproof form; and
granting a certificate inscribing the analysis result of the audience together with the information identifying the audience at a client's request.

6. The analysis result providing method of claim 1, further comprising:
presenting information to the client terminal corresponding to the analysis result, the information representing that the client is capable of nominating step-by-step selecting of an audience whom the question contents are presented.

7. The analysis result providing method of claim 1, further comprising:
selecting an audience whom the question contents are presented corresponding to the analysis result and presenting information to the client terminal, the information representing a possibility of presenting different question contents to the audience,

8. The analysis result providing method of claim 1, further comprising:
presenting information to the client terminal corresponding to the analysis result, the information representing that the client is capable of nominating step-by-step selecting of an audience whose information is disclosed to the client.

9. The analysis result providing method of claim 1, further comprising:
presenting the questions to the audience terminal belonging to a group thereby urging the audience to make the replies to the questions and further performing a data processing so that the replies from the audience terminal produce a barometer for rating the group.

10. The analysis result providing method of claim 1, further comprising:
presenting a variance of the audience in worth to the client, corresponding to formulation of the analysis result based on the replies obtained from the audience terminal.

11. An analysis result providing method for analyzing an audience in an analysis management server connected to an audience terminal, a client terminal and a question providing unit through communication lines and providing an analysis result to a client, comprising:
presenting a number of different and available themes to the client terminal;
recognizing a theme that the client selects from the themes presented to the client terminal;
memorizing the theme selected by the client and one or plural groups of questions by a plurality of clients registered for the theme selected, correspondingly;
when an access is generated from the audience terminal having the theme nominated, presenting a group of questions corresponding to the theme nominated to the audience terminal thereby urging the audience to make replies to the questions and further obtaining the replies; and
presenting the replies to the plurality of clients registered for the theme, in a browseable form where analysis results by different question contents are combined with each other, based on the replies obtained.

12. The analysis result providing method of claim 11, wherein
it is carried out to present a question-group using fee in case of obtaining the replies as a result of presenting the question contents to the audience terminal, thereby urging the client to select the question contents.

13. The analysis result providing method of claim 11, wherein
when using a plurality of different question contents, it is carried out to present a discounting of a question-group using fee.

14. The analysis result providing method of claim 11, wherein
when receiving a payment of a question-group using fee in case of obtaining the replies as a result of presenting the question contents to the audience terminal, it is executed to pay part of the question-group using fee to the side of the question providing unit.

15. The analysis result providing method of claim 11, further comprising:
allowing the analysis result of the audience based on accumulated replies to correspond to information identifying the audience and further accumulating the analysis and the information in an outside-leakproof form; and
granting a certificate inscribing the analysis result of the audience together with the information identifying the audience at a client's request.

16. The analysis result providing method of claim 11, further comprising:
presenting information to the client terminal corresponding to the analysis result, the information representing that the client is capable of nominating step-by-step selecting of an audience whom the question contents are presented.

17. The analysis result providing method of claim 11, further comprising:
selecting an audience whom the question contents are presented corresponding to the analysis result and presenting information to the client terminal, the information representing a possibility of presenting different question contents to the audience.

18. The analysis result providing method of claim 11, further comprising:
presenting information to the client terminal corresponding to the analysis result, the information representing that the client is capable of nominating step-by-step selecting of an audience whose information is disclosed to the client.

19. The analysis result providing method of claim 11, further comprising:
presenting the questions to the audience terminal belonging to a group thereby urging the audience to make the replies to the questions and further performing a data processing so that the replies from the audience terminal produce a barometer for rating the group.

20. The analysis result providing method of claim 11, further comprising:
presenting a variance of the audience in worth to the client, corresponding to formulation of the analysis result based on the replies obtained from the audience terminal.

21. An analysis result providing method for analyzing an audience in an analysis management server connected to an audience terminal, a client terminal and a question providing unit through communication lines and providing an analysis result to a client, comprising:
presenting a number of different and available question contents from the question providing unit to the audience terminal, thereby urging the audience to select a group of questions composed of the number of question contents; and
on establishment of the selected group of questions corresponding to the audience terminal urging the audience to make replies to the selected group of questions and further presenting the replies to the audience terminal, in a browseable form where analysis results by different question are combined with each other, based on the obtained replies.

22. The analysis result providing method of claim 21, wherein
it is carried out to present a question-group using fee in case of obtaining the replies as a result of presenting the question contents to the audience terminal, thereby urging the client to select the question contents.

23. The analysis result providing method of claim 21, wherein
when using a plurality of different question contents, it is carried out to present a discounting of a question-group using fee.

24. The analysis result providing method of claim 21, wherein
when receiving a payment of a question-group using fee in case of obtaining the replies as a result of presenting the question contents to the audience terminal, it is executed to pay part of the question-group using fee to the side of the question providing unit.

25. The analysis result providing method of claim 21, further comprising:
allowing the analysis result of the audience based on accumulated replies to correspond to information identifying the audience and further accumulating the analysis and the information in an outside-leakproof form; and
granting a certificate inscribing the analysis result of the audience together with the information identifying the audience at a client's request.

26. The analysis result providing method of claim 21, further comprising:
presenting the questions to the audience terminal belonging to a group thereby urging the audience to make the replies to the questions and further performing a data processing so that the replies from the audience terminal produce a barometer for rating the group.

27. An analysis result providing method for analyzing an audience in an analysis management server connected to an audience terminal, a client terminal and a question providing unit through communication lines and providing an analysis result to a client, comprising:
presenting a number of different and available question contents from the question providing unit to the client terminal;
recognizing a group of questions that the client selects from the question contents presented to the client;
memorizing the group of questions selected and the client in correspondence with each other;
when an access including information identifying the client is generated from the audience terminal, presenting the group of questions corresponding to the client to the audience terminal thereby urging the audience to make replies to the questions and further obtaining the replies; and
allowing the analysis result of the audience based on the replies obtained to correspond to information identifying the audience, further accumulating the analysis result and the information in an outside-leakproof form, and granting a certificate inscribing the analysis result of the audience together with the information identifying the audience at a client's request.

28. An analysis result providing method for analyzing an audience in an analysis management server connected to an audience terminal, a client terminal and a question providing unit through communication lines and providing an analysis result to a client, comprising:
presenting a number of different and available themes to the client terminal;
recognizing a theme that the client selects from the themes presented to the client;
memorizing the theme selected and the client, in correspondence with each other;
when an access is generated from the audience terminal having the theme nominated, presenting the group of questions corresponding to the theme to the audience terminal thereby urging the audience to make replies to the questions and further obtaining the replies; and
allowing the analysis result of the audience based on the replies obtained to correspond to information identifying the audience, further accumulating the analysis result and the information in an outside-leakproof form, and granting a certificate inscribing the analysis result of the audience together with the information identifying the audience at a client's request.

29. An analysis result providing system for analyzing an audience in an analysis management server connected to an audience terminal, a client terminal and a question providing unit through communication lines and providing an analysis result to a client, the analysis management server comprising:
means for making a number of different question contents from the question providing unit available;
means for memorizing a group of questions that the client selects from available groups of questions and the client in correspondence with each other; and
means for presenting the group of questions corresponding to the client to the audience terminal when an access including information identifying the client is generated from the audience terminal thereby urging the audience to make replies to the group of questions, the presenting means further accumulating the replies and processing the accumulated replies to a browseable form combined with analysis results by different question contents, based on the accumulated replies.

30. An analysis result providing system for analyzing an audience in an analysis management server connected to an audience terminal, a client terminal and a question providing unit through communication lines and providing an analysis result to a client, the analysis management server comprising:
means for making a number of different question contents from the question providing unit available;
means for memorizing one or plural groups of questions by a plurality of clients registered for a theme correspondingly; and
means for presenting the one or plural groups of questions corresponding to the theme to the audience terminal when an access is generated from the audience terminal having the theme nominated thereby urging the audience to make replies to the questions, the presenting means further accumulating the replies and processing the accumulated replies into a browseable form combined with analysis results by different question contents to a plurality of client terminals registered for the theme, based on the accumulated replies.
